(19) United States
(12) Patent Application Publication
(10) Pub. No.: US 2019/0130623 A1
(43) Pub. Date: May 2, 2019

(54) SYSTEM AND METHOD FOR ELECTRONIC GREETING CARDS

(71) Applicants: Mark DURANTE, Houston, TX (US); Thomas JACOBSEN, Tomball, TX (US)

(72) Inventors: Mark DURANTE, Houston, TX (US); Thomas JACOBSEN, Tomball, TX (US)

(21) Appl. No.: 16/174,579

(22) Filed: Oct. 30, 2018

Related U.S. Application Data
(60) Provisional application No. 62/578,925, filed on Oct. 30, 2017.

(51) Int. Cl. G06T 11/60; G06T 13/80; G10L 15/26

(52) U.S. Cl. CPC G06T 11/60; G10L 15/265; G06T 13/80

(57) ABSTRACT

A system and method for electronic greeting cards includes receiving a selection of a background image, obtaining visual media to overlay on the background image, obtaining a personal message to overlay on the background image, obtaining a signature to overlay on the background image, and displaying the electronic greeting card. Displaying the electronic greeting card includes displaying the background image, displaying the visual media over a first portion of the background image, displaying the personal message over a second portion of the background image, and displaying the signature over the background image. In some embodiments the visual media is a drawing including a sequence of drawing strokes recorded when the drawing was obtained. In some embodiments, the personal message is displayed as text at a reading speed. In some embodiments, the signature includes a sequence of strokes captured when the signature was obtained.

### RELATED APPLICATIONS

The present application claims priority to U.S. Provisional Patent Application No. 62/578,925, filed Oct. 30, 2017, the entire contents of which is incorporated herein by reference.

### TECHNICAL FIELD

The present disclosure relates generally to the creation and display of electronic greeting cards.

### BACKGROUND

E-commerce and electronic communication have become thriving components of the information age. As part of this, gifts, gift cards, and communication are increasingly replacing traditional methods of communication using written notes, packages, etc. For example, rather than going to the store and purchasing a greeting card (e.g., a birthday card) and sending the greeting card to a recipient, people are becoming increasing more likely to send an electronic communication instead. And while these electronic communications may include a personal message, they often lack the warmth and sentimentality of more traditional greeting cards.

Accordingly, it would be advantageous to provide improved methods of creating and displaying electronic greeting cards.

### SUMMARY

Consistent with some embodiments, a method performed by a processor for creating an electronic greeting card includes receiving a selection of a background image, obtaining visual media to overlay on the background image, obtaining a personal message to overlay on the background image, obtaining a signature to overlay on the background image, and displaying the electronic greeting card. Displaying the electronic greeting card includes displaying the background image, displaying the visual media over a first portion of the background image, displaying the personal message over a second portion of the background image, and displaying the signature over the background image.

Consistent with some embodiments, a computing device includes a memory and a processor coupled to the memory. The processor is configured to receive a selection of a background image, obtain visual media to overlay on the background image, obtain a personal message to overlay on the background image, obtain a signature to overlay on the background image, and display an electronic greeting card. To display the electronic greeting card the processor is configured to display the background image, display the visual media over a first portion of the background image, display the personal message over a second portion of the background image, and display the signature over the background image.

Consistent with some embodiments, a non-transitory machine-readable medium comprising a plurality of machine-readable instructions which when executed by one or more processors associated with computing device are adapted to cause the one or more processors to perform a method. The method includes receiving a selection of a background image, obtaining visual media to overlay on the background image, obtaining a personal message to overlay on the background image, obtaining a signature to overlay on the background image, and displaying the electronic greeting card. Displaying the electronic greeting card includes displaying the background image, displaying the visual media over a first portion of the background image, displaying the personal message over a second portion of the background image, and displaying the signature over the background image.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

FIG. 1 is a simplified diagram of a computing system according to some embodiments.

FIG. 2 is a simplified diagram of a method of creating an electronic greeting card according to some embodiments.

FIGS. 3A-3C are simplified diagrams of a user interface for creating an electronic greeting card according to some embodiments.

FIG. 4 is a simplified diagram of a data structure for recording a drawing according to some embodiments.

FIG. 5 is a simplified diagram of a data structure for recording a signature according to some embodiments.

FIG. 6 is a simplified diagram of a method of displaying an electronic greeting card according to some embodiments.

FIGS. 7A-7G are simplified diagrams of an electronic greeting card during various stages of playback according to some embodiments.

FIGS. 8A-8C are simplified diagrams of an electronic greeting card according to some embodiments.

In the figures, elements having the same designations have the same or similar functions.

### DETAILED DESCRIPTION

This description and the accompanying drawings that illustrate inventive aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail in order not to obscure the invention. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

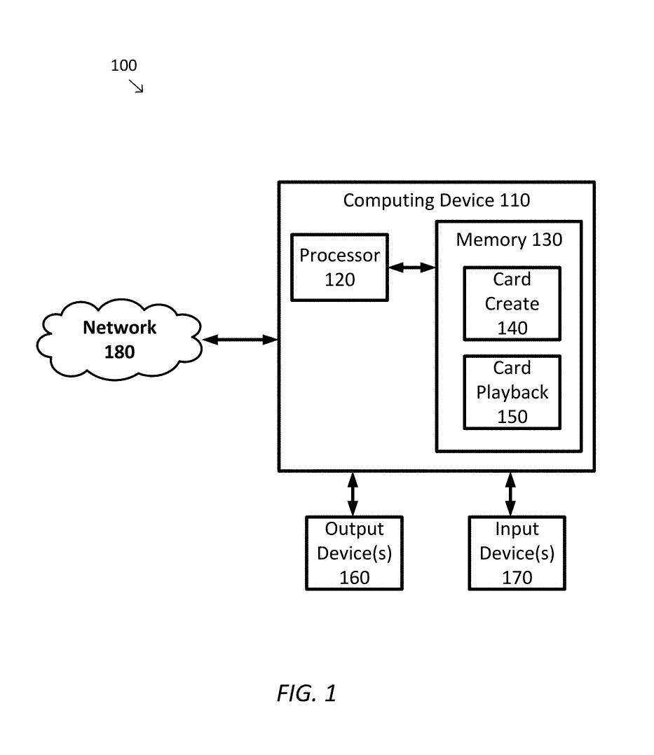

FIG. 1 is a simplified diagram of a computing system 100 according to some embodiments. As shown in FIG. 1, computing system 100 includes a computing device 110. Computing device 110 includes a processor 120 coupled to memory 130. Operation of computing device 110 is controlled by processor 120. And although computing device 110 is shown with only one processor 120, it is understood that processor 120 may be representative of one or more central processing units, multi-core processors, microprocessors, microcontrollers, digital signal processors, field programmable gate arrays (FPGAs), application specific integrated circuits (ASICs), graphics processing units (GPUs), and/or the like in computing device 110. In some examples, computing device 110 may be a mobile device such as a smart phone, tablet, and/or the like.

Memory 130 may be used to store software executed by computing device 110 and/or one or more data structures used during operation of computing device 110. Memory 130 may include one or more types of machine readable media. Some common forms of machine readable media may include floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read.

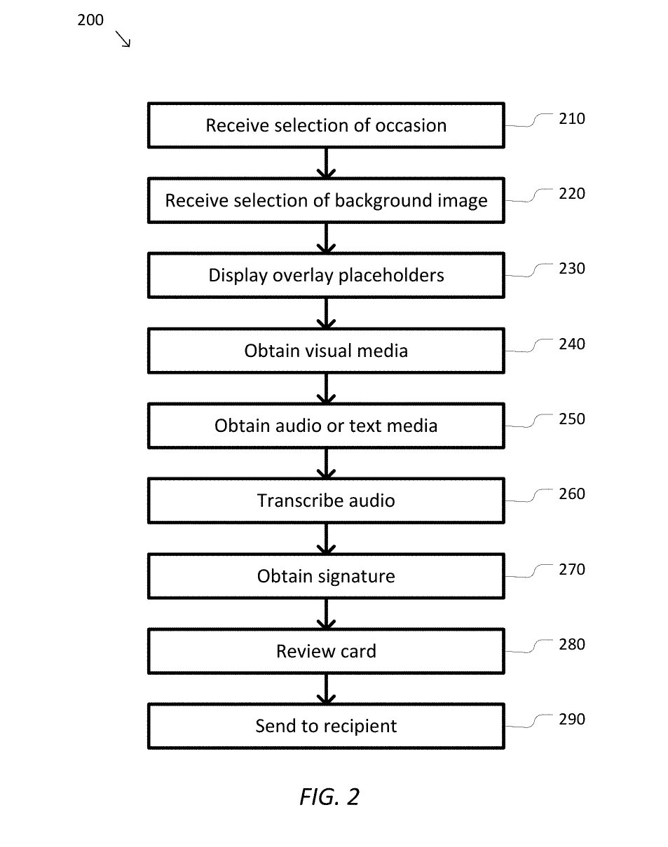

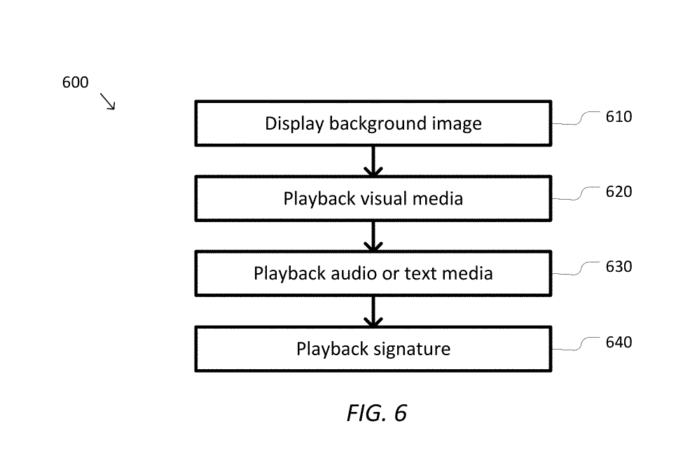

As shown, memory 130 includes a card creation module 140 and a card playback module 150. Card creation module 140 is responsible for aiding a user in creating an electronic greeting card as is discussed in further detail with respect to FIG. 2. Card playback module 150 is responsible for aiding a user in displaying and/or playing back an electronic greeting card as is discussed in further detail with respect to FIG. 6. In some examples, one or both of card creation module 140 and/or card playback module 150 may be stand-alone applications. In some examples, card playback module 150 may be used separately from card creation module 140 so that recipients of the electronic greeting cards described herein are able to play back the electronic greeting cards without needing to have card creation module 140.

Although memory 130 is shown only with card creation module 140 and card playback module 150, memory 130 may include other modules. In some examples, the other modules may include a calendaring module for keeping track of important dates, sending reminders to create and/or send electronic greeting cards, and/or the like.

Computing device 110 is further coupled to one or more output devices 160 and one or more input devices 170. In some examples, the one or more output devices 160 include one or more of a display screen, a speaker, and/or the like. In some examples, the display screen may be a small form-factor display, such as is commonly found on smart phones, tablets, and/or the like. In some examples, the display screen may be a touch screen and also function as one of the one or more input devices 170. In some examples, the one or more input devices 170 may include a camera (for capturing images and video), a microphone (for capturing audio), and/or a pick/stroke device (for capturing selections, strokes, and/or the like). In some examples, the pick/stroke device may be a mouse, a trackball, a touchpad, a joystick, a touch screen, and/or the like.

Computing device 110 is further coupled to a network 180. Network 180 may be used to receive content for inclusion in electronic greeting cards, send electronic greeting cards to a recipient, and/or the like. In some examples, network 180 may include a combination of one or more of a wireless network, a wired network (e.g., an Ethernet), a cellular network, a local area network, a wide area network (e.g., the Internet), and/or the like.

Even though there are a variety of options for sending electronic communications (e.g., emails, text messages, social media messages, and/or the like), these electronic communications typically lack the warmth and emotion that are possible using the electronic greeting cards as further described herein. Text-based messages, even when they include a personal message, are often quite sterile. Approaches to electronic greeting cards that attempt to emulate their paper counterparts often provide only a static electronic greeting that fails to fully leverage features of modern electronic devices, such as computing device 110. Approaches that attempt to include audio, video, and animation also typically lack suitable warmth and emotion as they are generally limited to stock animations with limited customization. In contrast, the electronic greeting cards as discussed in further detail herein are able to better leverage the capabilities the modern computing device so as to better convey warmth and emotion, which are powerful components of greeting cards. In addition, the electronic greeting cards as described in more detail herein are able to convey to the recipient the impression of being present as the electronic greeting card is being created (a feature which is not possible with traditional paper greeting cards and other electronic greeting card systems), which can further aid in the conveying of warmth and emotion.

FIG. 2 is a simplified diagram of a method 200 of creating an electronic greeting card according to some embodiments. One or more of the processes 210-290 of method 200 may be implemented, at least in part, in the form of executable code stored on non-transitory, tangible, machine-readable media that when run by one or more processors (e.g., the processor 120 in computing device 110) may cause the one or more processors to perform one or more of the processes 210-290. In some embodiments, method 200 may be performed by a module, such as card creation module 140.

In some embodiments, the processes of method 200 may be performed in other orders than those implied by the flowchart of FIG. 2. In some examples, processes 240, 250, and 270 may be performed in any order, repeated multiple times, and/or the like. In some examples, one or more of processes 210-270 may be repeated, if the review of the electronic greeting card during process 280 is deemed unsatisfactory, before sending the electronic greeting card to a recipient using process 290. In some embodiments, process 260 is optional and may be omitted.

At a process 210, a selection of occasion is received from a user. In order to aid the user in creating the electronic greeting card, it is helpful to know the particular occasion for which the electronic greeting card is to be sent (e.g., birthday, anniversary, graduation, and/or the like). In some examples, the selection of the occasion may be implemented as a selection from a list, a group of icons, a menu, and/or the like.

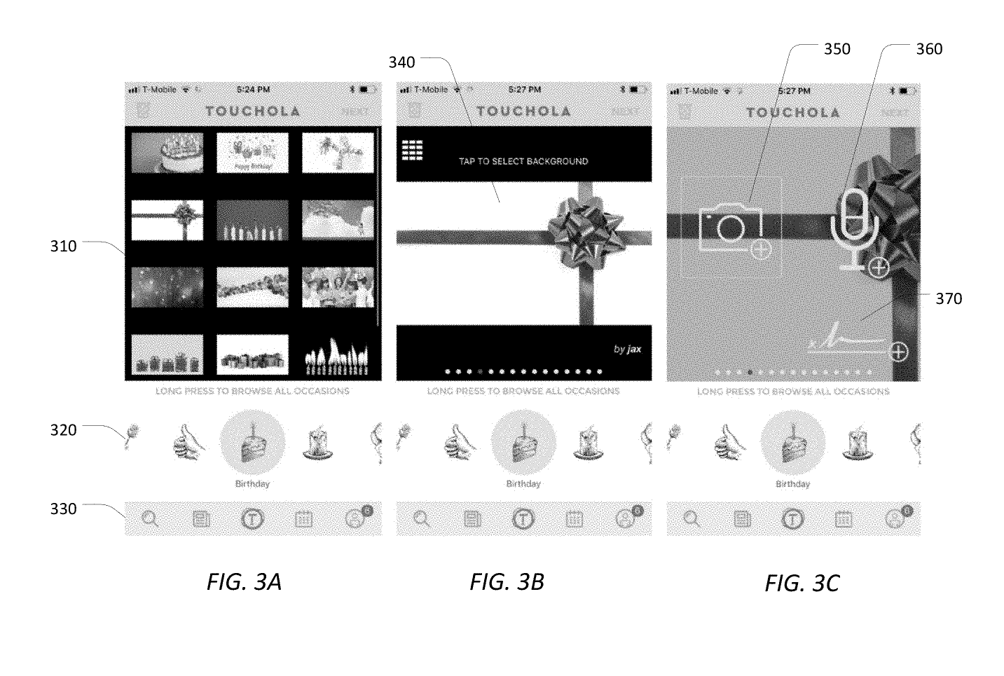

FIG. 3A is a simplified diagram of a user interface for aiding a user in the selection of the occasion. As shown in FIG. 3A, the user interface is suitable for use on a small form factor display, such as those commonly found on a smart phone, tablet, and/or the like. As shown, the user interface is configured for use with the display in a portrait orientation, however, one of skill in the art would understand that other configurations, landscape orientation, and/or the like are possible. The user interface of FIG. 3A is divided into three regions. A thumbnail region 310 includes thumbnails for various stock background images for the electronic greeting card. To accommodate more thumbnails, thumbnail region 310 may be scrolled left, right, up, or down using swipes, scroll gadgets (not shown), and/or the like. The user interface of FIG. 3A further includes an occasion selection region 320 showing different possible occasions for the electronic greeting card. Like thumbnail region 310, occasion selection region 320 may also be scrollable. Occasion selection region 310 may include common occasions, such as birthday, graduation, birth, anniversary, just because (e.g., no occasion or no specific occasion), and/or the like. When the user selects an occasion (e.g., “Birthday” as shown in FIG. 3A) by, for example, pressing or selecting an occasion in occasion selection region 320, thumbnail region 310 may be updated to display thumbnails of background images associated with the selected occasion or generic images when “Just Because” is selected. In some examples, a long press and/or a gadget (not shown) may be used to unselect the occasion and view background images for all occasions within thumbnail region 310. The user interface of FIG. 3A further includes a menu region 330 that may include gadgets or icons for searching, accessing a calendaring system, accessing social media, and/or the like.

FIG. 3B is a simplified diagram of a user interface for previewing a background image. As shown in FIG. 3B, the user interface is suitable for use on a small form factor display, such as those commonly found on a smart phone, tablet, and/or the like. As shown, the user interface is configured for use with the display in a portrait orientation, however, one of skill in the art would understand that other configurations, landscape orientation, and/or the like are possible. The user interface of FIG. 3B also includes the occasion selection region 320 and menu region 330 from FIG. 3A. In some examples, when a thumbnail is selected from thumbnail region 310, a preview of the selected thumbnail is displayed in a preview region 340 that replaces thumbnail region 310. In some examples, preview region 340 may be scrolled left, right, up, or down using swipes, scroll gadgets (not shown), and/or the like in order to view a preview of other background images. The user interface of FIG. 3B may also include other controls and/or gadgets (not shown) for recoloring the background image, accessing information about the artist, searching for other background images by the same artist, searching for similar background images, and/or the like.

Referring back to FIG. 2, at a process 220, a selection of a background image is received. The selection of the background image may implemented as a selection from a list, a group of icons, a group of thumbnails (e.g., from thumbnail region 310) a menu, and/or the like. As shown in the user interface examples of FIG. 3B, the background image may be selected by tapping, clicking, activating a gadget (e.g., a button, which is not shown), and/or the like.

At a process 230, overlay place holders are displayed on the background image selected during process 220. Each of the overlay place holders represent additional content that may be added to the electronic greeting card as is described in further detail below.

FIG. 3C is a simplified diagram of a user interface after the selection of a background image and display of the overlay placeholders. As shown in FIG. 3C, the user interface is suitable for use on a small form factor display, such as those commonly found on a smart phone, tablet, and/or the like. As shown, the user interface is configured to use with the display in a portrait orientation, however, one of skill in the art would understand that other configurations, landscape orientation, and/or the like are possible. The user interface of FIG. 3C also includes the occasion selection region 320 and menu region 330 from FIGS. 3A and/or 3B. The user interface of FIG. 3C includes an overlay placeholder for visual media 350, an overlay placeholder for audio or text media 360, and an overlay placeholder for a signature 370. Each of the overlay placeholders 350-370 includes a graphic suggestive of the type of content that may be added to the electronic greeting card. And although the user interface of FIG. 3C is shown with three overlay placeholders, user interfaces with a subset of overlay placeholders 350-370 and/or other overlay placeholders are possible. In addition, the placement and/or relative location of overlay placeholders 350-370 is representative only. In some example, the user interface of FIG. 3C may be used to delete one or more unwanted overlay placeholders, add one or more additional overlay placeholders, reposition one or more of the overlay placeholders, and/or the like.

Referring back to FIG. 2, at a process 240 visual media is obtained. In some examples, the process 240 may be triggered by selection/activation of the overlay placeholder for visual media 350. In some examples, the visual media may include an image, a sequence of images, a video, and/or a drawing. In some examples, the image, the sequence of images, and/or the video may be selected from a media library on the computing device performing method 200 and/or from a remote server, such as a cloud storage repository with media content. In some examples, the image, sequence of images, and/or the video may be captured using an imaging device (e.g., a camera) on the computing device performing method 200.

In some examples, the drawing may be obtained using a drawing module and/or the like included as part of and/or separate from the card creation module that is performing the card creation processes of method 200. In some examples, the drawing module may include one or more controls, gadgets, and/or the like for selecting a drawing canvas size, drawing tools of various shapes, sizes of the drawing tools, colors to draw in, transparency levels, stock image elements, and/or the like. In some examples, the drawing may be obtained as a static final image (e.g., as a bitmap). In some examples, the drawing may be obtained as a dynamic image that may be “redrawn” when the electronic greeting card is viewed as is described in further detail below.

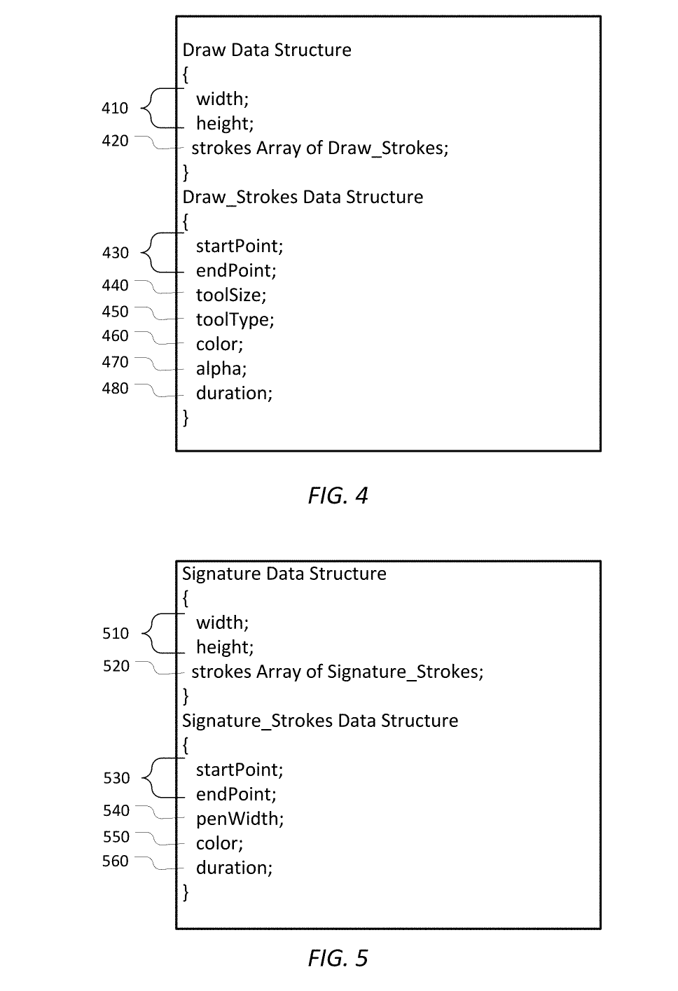

FIG. 4 is a simplified diagram of a data structure for recording a drawing according to some embodiments. As shown in FIG. 4, a draw data structure includes fields for specifying a size 410 of a drawing (e.g., by specifying a width and a height). In some examples, the width and/or height may be represented as dimensions in pixels and/or as a percentage (0.0 to 1.0) of a full electronic greeting card size and/or a display device size. The draw data structure further includes an array or other ordered collection 420 of Draw_Strokes. The Draw_Strokes data structure includes fields for the starting and ending points 430 of a drawing stroke, a tool size field 440, a tool type field 450, a color field 460, a transparency level field (e.g., an alpha blending factor) 470, and a duration field 480. In some examples, the starting and ending points may be described as two-dimensional locations within the drawing as specified using pixel dimensions, percentages of the drawing canvas, percentages of the full electronic greeting card size, percentages of the display device size, and/or the like. In some examples, the duration field 480 indicates that amount of time spent drawing the corresponding drawing stroke. In some examples, each of the drawing strokes may correspond to a piece-wise linear portion of a longer and possibly curved drawing stroke. In some examples, one or more of the fields of the Draw_Stroke data structure, such as transparency level field 470 and/or duration field 480, are optional and may be omitted. In some examples, the Draw_Stroke data structure may include other fields (not shown) suitable for parameterizing curved strokes, such as quadratics, B-splines, and/or the like.

Referring back to FIG. 2, at a process 250, audio or text media is obtained. In some examples, the process 250 may be triggered by selection/activation of the overlay placeholder for audio or text media 360. In some examples, audio media may be selected from a media library and/or captured using a microphone. In some examples, text media may be entered using a text entry dialog. In some examples, the audio or text media may represent a personal message to be included with the electronic greeting card.

At an optional process 260, any audio media selected and/or captured during process 250 may be transcribed to text. In some examples, a text recognition module is used to transcribe the text to audio. Once transcribed, the transcribed text is parsed into lines of a configurable length to allow for its display within the electronic greeting card. In some examples, the text may additionally be displayed in an editable text dialog box to allow the user to correct spelling, adjust the content, and/or the like. In some examples, the user may additionally designate whether the selected audio is to be part of the electronic greeting card.

At a process 270, a signature is obtained. In some examples, the signature may be obtained using a stroke capturing module and/or the like included as part of and/or separate from the card creation module that is performing the card creation processes of method 200. In some examples, the stroke capturing module may include one or more controls, gadgets, and/or the like for selecting a signature canvas size, sizes of the signature tool, colors of the signature, and/or the like. In some examples, the signature may be captured via a touch screen, stylus, and/or other stroke input device. In some examples, the signature may be obtained as a static final image (e.g., as a bitmap). In some examples, the signature may be obtained as a dynamic signature that may be “re-signed” when the electronic greeting card is viewed as is described in further detail below.

FIG. 5 is a simplified diagram of a data structure for recording a signature according to some embodiments. As shown in FIG. 5, a signature data structure includes fields for specifying a size 510 of a signature (e.g., by specifying a width and a height). In some examples, the width and/or height may be represented as dimensions in pixels and/or as a percentage (0.0 to 1.0) of a full electronic greeting card size and/or a display device size. The signature data structure further includes an array or other ordered collection 520 of Signature Strokes. The Signature Strokes data structure includes fields for the starting and ending points 530 of a drawing stroke, a pen width field 540, a color field 550, and a duration field 560. In some examples, the starting and ending points may be described as two-dimensional locations within the drawing as specified using pixel dimensions, percentages of the drawing canvas, percentages of the full electronic greeting card size, percentages of the display device size, and/or the like. In some examples, the duration field 560 indicates that amount of time spent drawing the corresponding signature stroke. In some examples, each of the signature strokes may correspond to a piece-wise linear portion of a longer and possibly curved signature stroke. In some examples, one or more of the fields of the Signature_Stroke data structure, such as duration field 560, are optional and may be omitted. In some examples, the Signature_Stroke data structure may include other fields (not shown) suitable for parameterizing curved strokes, such as quadratics, B-splines, and/or the like.

At a process 280, the electronic greeting card is reviewed. In some examples, review of the electronic greeting card may be triggered automatically by completing the creation of the electronic greeting card, in response to the user reorienting the display of the computing device into landscape mode (e.g., by rotating a smart phone or tablet from portrait to landscape orientation), activation of a button or other gadget, and/or the like.

FIG. 6 is a simplified diagram of a method 600 of displaying an electronic greeting cards according to some embodiments. One or more of the processes 610-640 of method 600 may be implemented, at least in part, in the form of executable code stored on non-transitory, tangible, machine-readable media that when run by one or more processors (e.g., the processor 120 in computing device 110) may cause the one or more processors to perform one or more of the processes 610-640. In some embodiments, method 600 may be performed by a module, such as card playback module 150. In some embodiments, method 600 may be used to review and/or display an electronic greeting card created by processes 210-270 of method 200.

In some embodiments, the processes of method 600 may be performed in other orders than those implied by the flowchart of FIG. 6. In some examples, processes 620-640 may be performed in other orders, such as an order specified during creation of the electronic greeting card. In some examples, method 600 may include fewer, more and/or different playback processes depending on the various media included in the electronic greeting card.

In some embodiments, the operation of method 600 may depend on the type and/or orientation of the display screen of the computing device used to display the electronic greeting card. In some examples, the electronic greeting card is displayed within a framed or unframed window or dialog. In some examples, the electronic greeting card may be scaled so as to be displayed in full screen mode, partial screen mode, cropped mode, and/or the like. In some examples, the partial screen and/or cropped modes may be used when the aspect ratio of the electronic greeting card is different than the display screen, window, or dialog. In some examples, the partial screen mode may include scaling the electronic greeting card so that it is fully visible on the display screen and/or within a window or dialog used for displaying the electronic greeting card. In some examples, the cropped mode may include scaling the electronic greeting card to fit the height of the display screen, window, or dialog used for displaying the electronic greeting card with the left and right sides being cropped and not displayed. In some examples, the full screen is used when the display screen is in a landscape orientation. In some examples, the partial screen and/or cropped modes may be used when the display screen is in a portrait orientation.

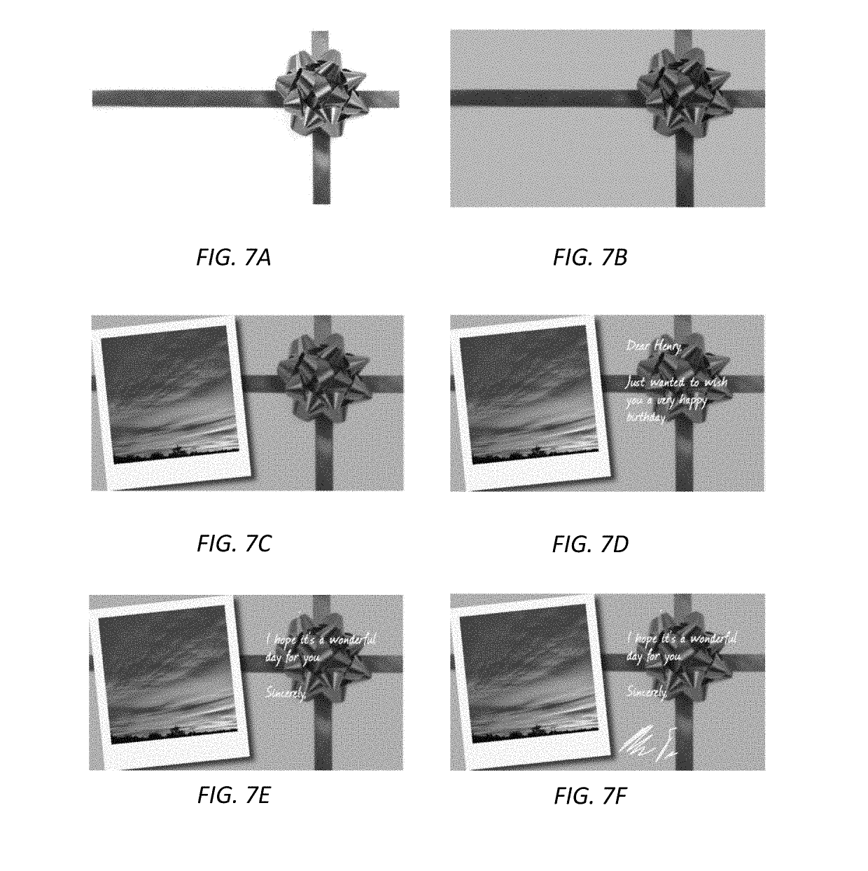

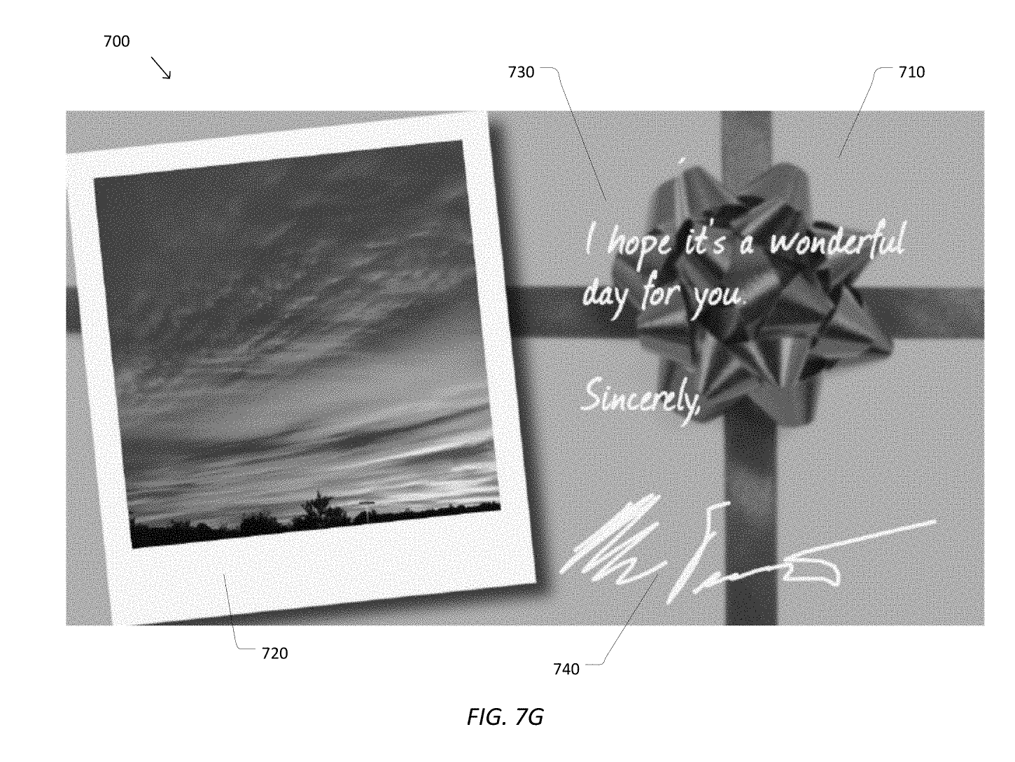

Illustration of method 600 is shown within the context of a representative electronic greeting card that is shown in various stages of display using FIGS. 7A-7G.

At a process 610, the background image of the electronic greeting card is displayed. The background image is scaled and then displayed on a display screen according to the display mode (as discussed above) chosen for displaying the electronic greeting card. In some examples, once the background image is displayed, a brief delay may occur (such as 0.1 to 2 seconds) before continuing with the rest of method 600. In some examples, the background image may be displayed and adjusted using a sequence of operations. In some examples, the operations may include displaying the background image as selected (see the representative example of FIG. 7A), and then altering the background image by performing one or more of adding a border, adding a shadow, slightly blurring the background image to deemphasize it, and adding a semi-transparent filter to further deemphasize the background image. A representative example of the background image after blurring and filtering is shown in FIG. 7B.

At a process 620, the visual media of the electronic greeting card is played back. Playback of the visual media depends on the type of visual media. When the visual media is an image, the image is displayed over the background image in the region designated for displaying visual media. When the visual media is a sequence of images, the sequence of images are displayed over the background image in the region designated for displaying visual media according to a timing script associated with the sequence of images. When the visual media is a video, the video is displayed over the background image in the region designated for displaying visual media. When the visual media is a drawing, the drawing may be played back as a static final image and/or as the sequence of drawing strokes as captured in a draw data structure, such as the draw data structure of FIG. 4. In some examples, playing back the drawing using the sequence of drawing strokes conveys to the viewer the sense of seeing the drawing recreated before their own eyes as if they were present when it was being drawn. In some examples, this can greatly increase the emotional impact of the electronic greeting card. In some examples, the visual media is scaled to match the scaling of the background image and/or to fill the region designated for displaying visual media. In some examples, the visual media is displayed within a border. In some examples, the border is displayed before or after playback of the visual media. In some examples, the border may appear and/or be faded in. In some examples, the visual media is displayed at slight angle (e.g., 1 to 10 degrees counter-clockwise) relative to the orientation of the background image. In some examples, the rotation may occur after playback of the visual media. A representative example of the electronic greeting card after playback of the visual media is shown in FIG. 7C where an image, a final image of a sequence of images, or final or representative frame of a video is shown with a white photo-like border, a black shadow, and slight counter-clockwise rotation.

At a process 630, the audio or text media of the electronic greeting card is played back. Playback of the audio or text media depends on the whether the media includes text, audio, or both. When the media includes audio, the audio may be played back on one or more speakers of the computing device being used to view the electronic greeting card. When the media includes text, the text may be played back statically and/or dynamically. In some examples, the text may be played back dynamically by introducing the text one line at a time with vertical scrolling occurring as appropriate when more lines of text are included than can be viewed at one time on the electronic greeting card. In some examples, each line of text may also be introduced one letter at a time and/or one word at a time according to comfortable reading speed (e.g., 100-400 words per minute) that may be set when the electronic greeting card is created. When the media includes both text and audio, the text may be displayed in sequence with the audio so that the text appears as each of the words is spoken. A representative example of text playback is shown in FIGS. 7D and 7E, with FIG. 7D showing text play back when it is partially complete and FIG. 7E showing text playback when it is complete with some portions of the played back text being scrolled out of view.

At a process 640, the signature of the electronic greeting card is played back. The signature may be played back statically as a complete signature and/or dynamically. In some examples, the signature may be played back dynamically by revealing it from left to right (e.g., as a swipe right) at a rate that may be set when the signature is captured. In some examples, the signature may be played back dynamically as a sequence of signature strokes as captured in a signature data structure, such as the signature data structure of FIG. 5. In some examples, playing back the signature dynamically using the dynamic introduction and/or the sequence of signature strokes conveys to the viewer the sense of seeing the signature being recreated before their own eyes as if they were present when the electronic greeting card is signed. In some examples, this can greatly increase the emotional impact of the electronic greeting card. In some examples, the signature is scaled to match the scaling of the background image and/or to fill the region designated for displaying a signature. In some examples, the signature is displayed above a signature line. A representative example of signature playback is shown in FIG. 7F where a portion of the signature is played back by left to right introduction or stroke playback.

A representative example of electronic greeting card 700 after it has been played back is shown in FIG. 7G. Electronic greeting card 700 includes a background image 710, an overlaid visual media 720 in the form of an image, a final image of a sequence of images, or final or representative frame of a video, an overlaid text media 730 after the text is fully scrolled (e.g., so that just the last portion of the text is being displayed), and a signature 740 after the signature has been played back. Visual media 720 is also shown with a white border and black shadow that resembles an older-style photograph or instant photograph that is rotated at a slight angle relative to electronic greeting card 700 to give the impression that visual media 720 was hand pasted onto electronic greeting card.

Referring back to FIG. 2, at a process 290, the electronic greeting card is sent to a recipient. In some examples, the electronic greeting card may be sent via email, text message, social media post, and/or the like. In some examples, the electronic greeting card may be sent as a file attached to the email, text message, or social media post and/or as a link with a uniform resource locator (URL) so that the electronic greeting card may be accessed from a server and/or other repository. Once received by the recipient, the recipient may display the electronic greeting card using method 600.

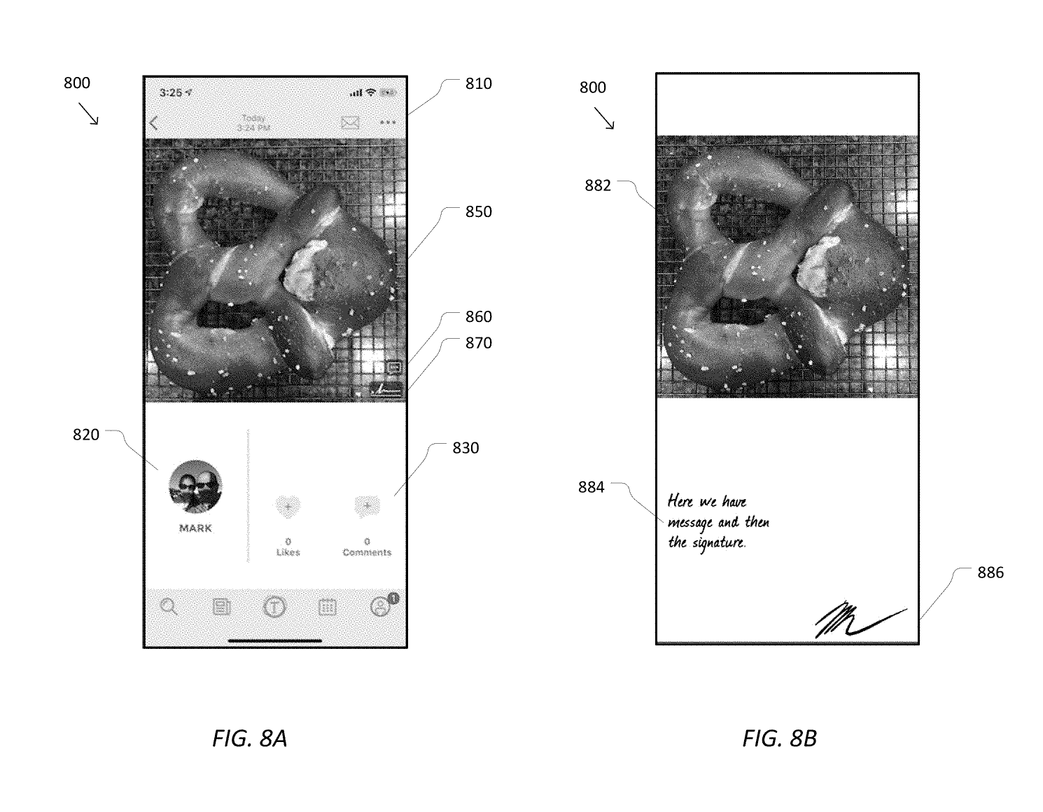

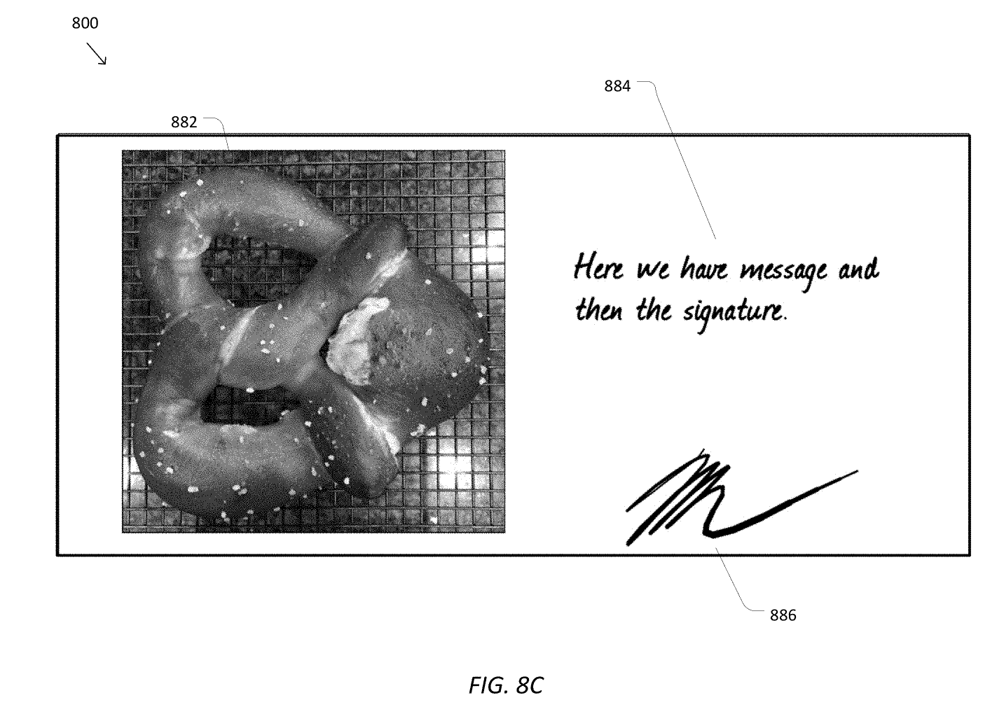

FIGS. 8A-8C are simplified diagrams of an electronic greeting card 800 according to some embodiments. FIG. 8A shows electronic greeting card 800 after it has been received, but before it has been opened by the recipient. As shown, electronic greeting card 800 is shown on a user interface demonstrating various features and interaction options. A messaging area 810 includes one or more gadgets or icons for using messaging features that may provide access to an inbox, message composition, and/or other related features. A sender icon 820 indicates displays the name and image of the sender. A reaction area 830 includes one or more icons for providing a reaction to electronic greeting card 800, such as heart/like, thumbs up, thumbs down, emoticons (e.g., smiley, surprise, questioning, and/or the like), and/or the like. A menu region 840, similar to menu region 330, that may include gadgets or icons for searching, accessing a calendaring system, accessing social media, and/or the like. A card image 850 showing an image representative of electronic greeting card 800, corresponding to the visual media of electronic greeting card 800 that is similar to visual media 720. Overlaid on visual media are one or more content icons that indicate the other content elements that are included with electronic greeting card 800. In the examples of FIG. 8A, the one or more content icons include a text media icon 860 indicating that electronic greeting card includes text media similar to text media 730 and a signature icon 870 indicating the electronic greeting card includes a signature similar to signature 740.

FIGS. 8B and 8C shown electronic greeting card 800 after playback including visual media 882, text media 884, and signature 886. In FIG. 8B, electronic greeting card 800 is shown as it might be played back when the playback device (e.g., a smart phone) is oriented in portrait mode, and in FIG. 8C, electronic greeting card 800 is shown as it might be played back when the playback device is oriented in landscape mode.

As discussed above and further emphasized here, FIGS. 2-8C are merely examples which should not unduly limit the scope of the claims. One of ordinary skill in the art would recognize many variations, alternatives, and modifications. According to some embodiments, one or more elements may be omitted from an electronic greeting card. In some examples, one or more of the background image 710, text media 730 and/or 884, signature 740 and/or 886 may be omitted from an electronic greeting card. When one or more of the text media and/or the signature is omitted, the corresponding content icon (e.g., text media icon 860 and/or signature 870) is omitted as well. In some examples, depending on which of the background image, the text media, and/or the signature are omitted, the size and/or position of the visual media may be adjusted to occupy more of the electronic greeting card.

According to some embodiments, methods 200 and/or 600 may include additional functionality. In some examples, methods 200 and/or 600 may include direct-messaging functionality whereby any user may send a message within the electronic greeting card application to any other user. The direct messaging functionality may include inboxes, notifications alerting the recipient of a message, composing functionality, and/or the like. In some examples, received messages may be badged with a reaction area similar to reaction area 830 providing one or reaction icons. In some examples, the messages may include text, images, drawing objects (e.g., similar those discussed with respect to the drawing module of process 240), signatures (e.g., similar to those discussed with respect to the stroke capturing module of process 270), and/or the like.

Some examples of computing devices, such as computing device 110 may include non-transitory, tangible, machine readable media that include executable code that when run by one or more processors (e.g., processor 120) may cause the one or more processors to perform the processes of methods 200 and/or 600. Some common forms of machine readable media that may include the processes of method 200 and/or 600 are, for example, floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method performed by a processor for creating an electronic greeting card, the method comprising:
receiving a selection of a background image;
obtaining visual media to overlay on the background image;
obtaining a personal message to overlay on the background image;
obtaining a signature to overlay on the background image; and
displaying the electronic greeting card by:
displaying the background image;
displaying the visual media over a first portion of the background image;
displaying the personal message over a second portion of the background image; and
displaying the signature over the background image.

2. The method of claim 1, further comprising sending the electronic greeting card to a recipient.

3. The method of claim 1, wherein the visual media is selected from a group consisting of an image, a sequence of images, a video, and a drawing.

4. The method of claim 1, wherein displaying the visual media comprises displaying the visual media with one or more of a border or a shadow.

5. The method of claim 1, wherein the visual media is displayed rotated relative to the background image.

6. The method of claim 1, further comprising blurring, filtering, or both blurring and filtering the background image.

7. The method of claim 1, wherein displaying the visual media comprises playing back a drawing as a sequence of drawing strokes recorded when the drawing was obtained.

8. The method of claim 1, wherein obtaining the personal message comprises:
obtaining an audio message; and
transcribing the audio message to text.

9. The method of claim 1, wherein displaying the personal message comprises displaying text in the personal message at a reading speed.

10. The method of claim 1, wherein displaying the signature comprises playing back a sequence of strokes captured when the signature was obtained.

11. The method of claim 1, wherein displaying the signature comprises revealing the signature from left to right.

12. The method of claim 1, further comprising displaying one or more overlay placeholders over the background image for requesting one or more of the visual media, the personal message, and the signature.

13. A computing device comprising:
a memory; and
a processor coupled to the memory and configured to:
receive a selection of a background image;
obtain visual media to overlay on the background image;
obtain a personal message to overlay on the background image;
obtain a signature to overlay on the background image; and
display an electronic greeting card by:
displaying the background image;
displaying the visual media over a first portion of the background image;
displaying the personal message over a second portion of the background image; and
displaying the signature over the background image.

14. The computing device of claim 13, wherein the processor is further configured to send the electronic greeting card to a recipient.

15. The computing device of claim 13, wherein the visual media is selected from a group consisting of an image, a sequence of images, a video, and a drawing.

16. The computing device of claim 13, wherein to display the visual media the processor is configured to rotate the visual media relative to the background image and display the visual media with one or more of a border or a shadow.

17. The computing device of claim 13, wherein to display the visual media the processor is configured to play back a drawing as a sequence of drawing strokes recorded when the drawing was obtained.

18. The computing device of claim 13, wherein to display the personal message the processor is configured to display text in the personal message at a reading speed.

19. The computing device of claim 13, wherein to display the signature the processor is configured to play back a sequence of strokes captured when the signature was obtained.

20. A non-transitory machine-readable medium comprising a plurality of machine-readable instructions which when executed by one or more processors associated with computing device are adapted to cause the one or more processors to perform a method comprising:
receiving a selection of a background image;
obtaining visual media to overlay on the background image;
obtaining a personal message to overlay on the background image;
obtaining a signature to overlay on the background image; and
displaying an electronic greeting card by:
displaying the background image;
displaying the visual media over a first portion of the background image;
displaying the personal message over a second portion of the background image; and
displaying the signature over the background image.
